(19) United States
(12) Patent Application Publication
(10) Pub. No.: US 2005/0176289 A1
(43) Pub. Date: Aug. 11, 2005

(54) Battery connector

(75) Inventor: Jen Jou Chang, Tu-Chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/054,998

(22) Filed: Feb. 9, 2005

(30) Foreign Application Priority Data
Feb. 10, 2004 (TW) 93201839

(51) Int. Cl. H01R 3/00

(52) U.S. Cl. 439/500

(57) ABSTRACT

A battery connector (100) adapted for mating with a complementary connector of a mobile phone includes a header (1), a socket (2) which can be movable in a lengthwise direction on the header and a plurality of contacts (3) retained in the header. The header defines a plurality of receiving cavities (111) for receiving the contacts. The socket includes a plurality of blocks (22) each defining a pair of chamfers (221) for correctly leading the complementary connector into the battery connector.

### BACKGROUND OF THE INVENTION

1. Field of the Invention

This invention generally relates to a battery connector and more particularly, to a battery connector used in a portable electronic device.

2. Description of the Prior Art

Battery connectors have been employed for holding various forms of batteries. U.S. Pat. No. 6,109,949 issued on Aug. 29, 2000 discloses a conventional battery connector adapted for mating with a complementary connector of a portable device. FIG. 1 shows a top view of the conventional battery connector. The conventional battery connector includes an insulative housing 20A and a plurality of contacts 21C retained in the housing 20A. The housing 20A defines a plurality of lead-in channels 22 for correctly leading the complementary connector thereinto. However, if the complementary connector mates with the battery connector inaccurately, terminals of the complementary connector are axially offset from the channels of the battery connector and easily be distorted or broken by the battery connector since the terminals only be leaded into the battery connector via the unmovable lead-in channels 22 of the battery connector.

Hence, an improved battery connector is desired to overcome the above problems and meet the increased transmission demand.

### BRIEF SUMMARY OF THE INVENTION

It is an object of the present invention to provide a battery connector with a better electrical performance.

In order to attain the object above, a battery connector adapted for mating with a complementary connector of a mobile phone includes a header, a socket which can be movable in a lengthwise direction on the header and a plurality of contacts retained in the header. The header defines a plurality of receiving cavities for receiving the contacts. The socket includes a plurality of blocks each defining a pair of chamfers for correctly leading the complementary connector into the battery connector.

Other objects, advantages and novel features of the invention will become more apparent from the following detailed description of the present embodiment when taken in conjunction with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is a top view of a conventional battery connector according to a prior art;

FIG. 2 is an exploded view of a battery connector according to the present invention;

FIG. 3 is a partially assembled view of FIG. 2 showing contacts assembled within a header;

FIG. 4 is an assembled view of the battery connector;

FIG. 5 is another assembled view of the battery connector; and

FIG. 6 is a bottom view of the battery connector.

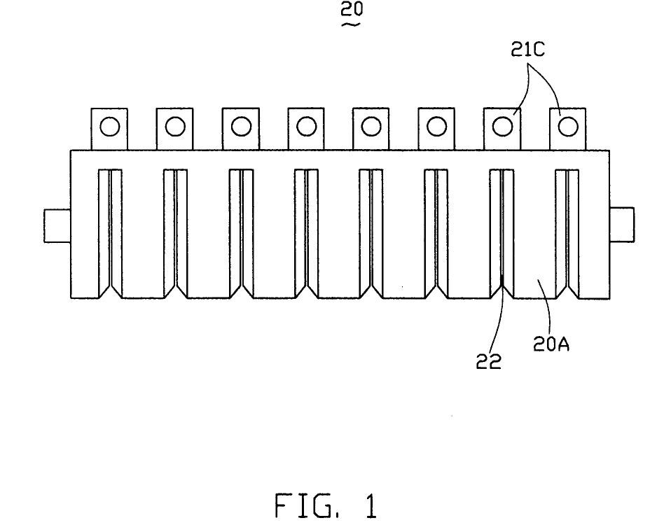

### DETAILED DESCRIPTION OF THE INVENTION

Reference will now be made in detail to the preferred embodiment of the present invention.

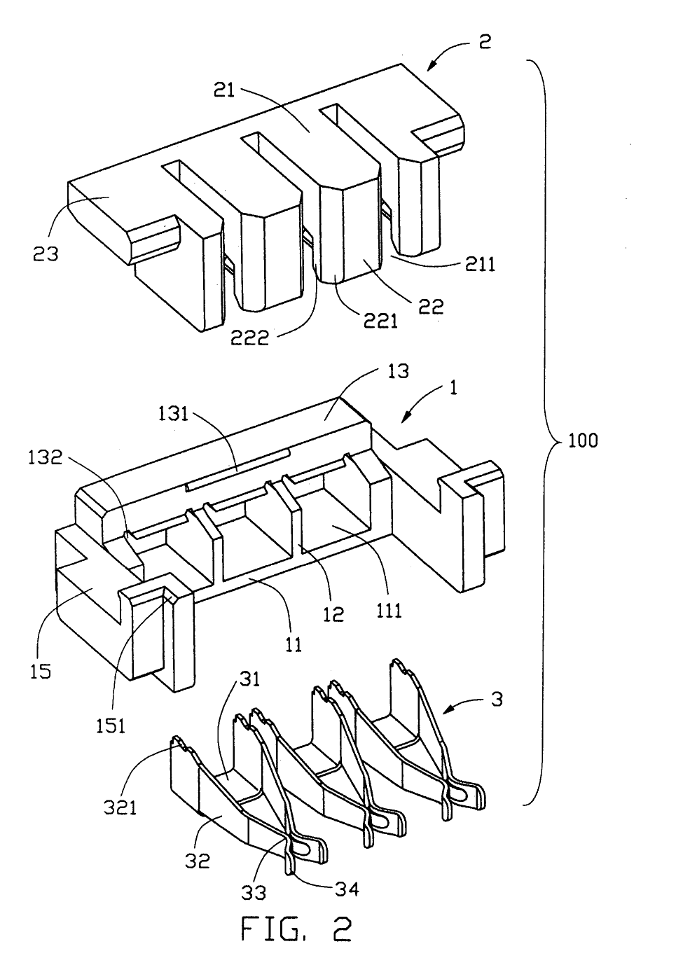

A battery connector 100 according to the present invention adapted for mounting on a printed circuit board (not shown), illustrated in FIG. 2, includes a header 1, a socket 2 for attaching to the header 1 and a plurality of contacts 3.

As depicted in FIG. 2, the header 1 includes a base portion 11 and a pair of arms 15 forwardly extending from opposite sides of the base portion 11. The base portion 11 defines a plurality of partitions 12 with a predetermined interval provided in a lengthwise direction of the base portion 11, thereby forming a plurality of receiving cavities 111 for receiving the contacts 3. The header 1 further includes an end portion 13 upwardly extending from a rear portion of the base portion 11. The end portion 13 connects with the partitions 12 and defines a plurality of channels 132 communicating with corresponding receiving cavities 111 and adjacent to the partitions 12. The end portion 13 forms a longitudinal rib 131 forwardly projecting from a front portion thereof. Each arm 15 includes a step portion 151 for resisting the socket 2 formed in a front portion thereof, as will be detailed hereinafter.

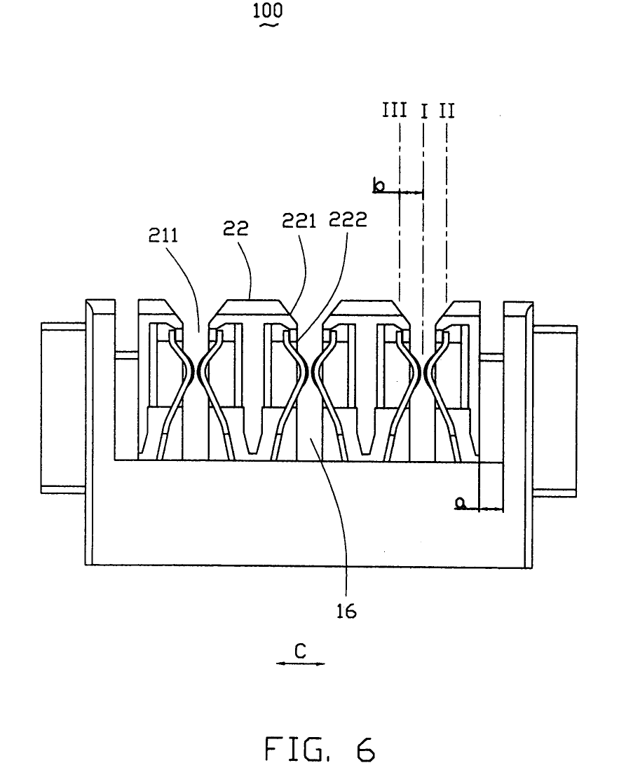

The socket 2 includes a main body 21 and defines a plurality of passageways 221 with a determined interval in a lengthwise direction of the main body 21, thereby forming a plurality of block 22. The passageways 221 and the corresponding receiving cavities 111 of the header 1 cooperatively form a plurality of receiving rooms 16 (shown in FIG. 6) for receiving the contacts 3. Each block 22 includes a pair of chamfers 221 in opposite sides thereof for conveniently leading a complementary connector (not shown) thereinto and a pair of resistance face 222 interiorly extending from the corresponding chamfers 221 for resisting the contacts 3, as will be detailed hereinafter. A pair of flanges 23 transversely extends from opposite sides of the main body 21.

Each contact 3 has a flat 31 and a pair of cantilevered beams 32 upwardly and forwardly extending from opposite sides of the flat 31 and toward each other. The cantilevered beams 32 include a pair of abutments 34 outwardly extending and toward each other in a free end thereof and a pair of bends 33 interiorly bent and mutually moving closer. The height of each abutment 34 is substantially equal to the height of the corresponding resistance face 222. Each cantilevered beam 32 forms a resistance portion 321 for engaging with the corresponding channel 132 of the header 1.

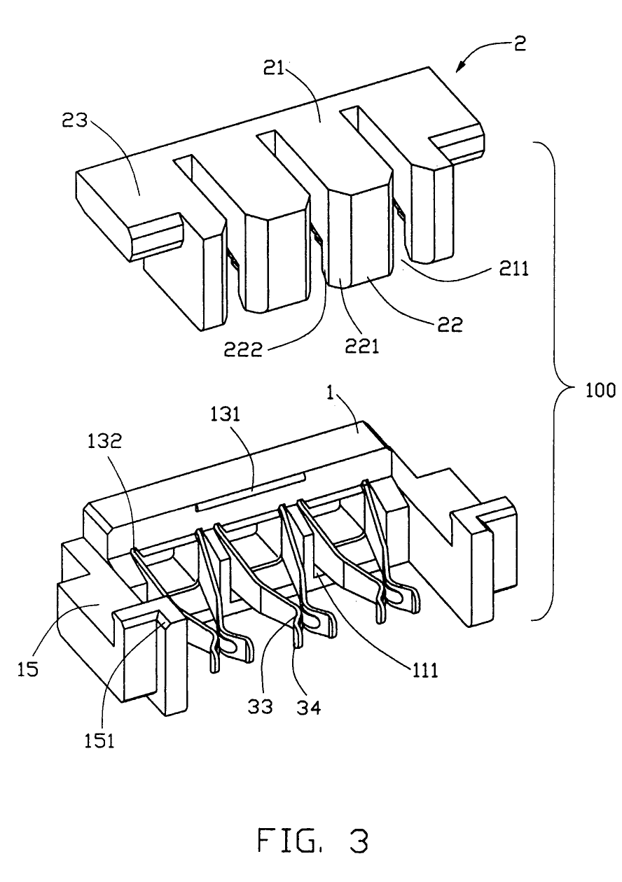

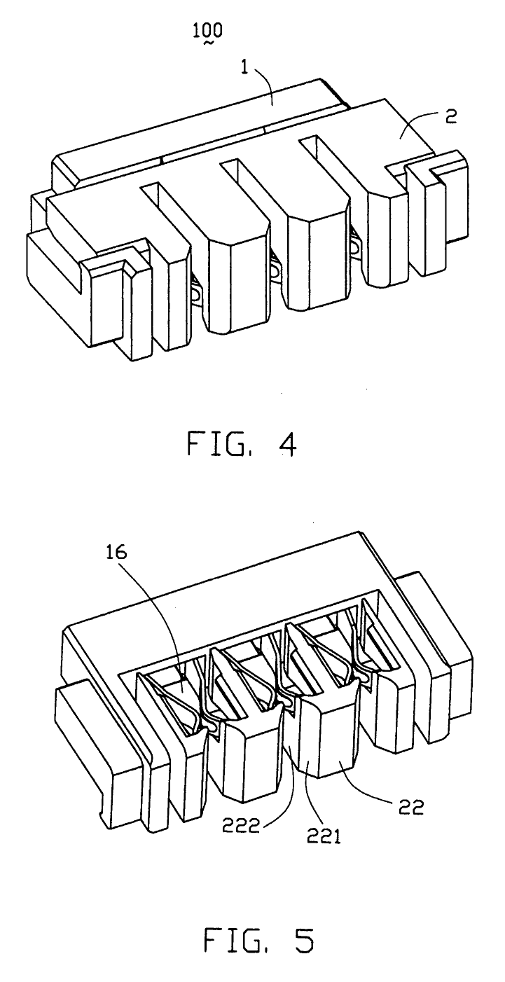

Referring to FIGS. 2-5, in assembly, the contacts 3 are inserted into the header 1, with the resistance portions 321 latching into the channels 132 of the header 1. The cantilevered beams 32 are provided between the arms 15 of the header 1. Then, the socket 2 is assembled on the header 1, with the flanges 23 seated on the arms 15 of the header 1 and being resisted by the stepped portion 151 and the longitudinal rib 131. At the same time, the contacts 3 are received in the corresponding receiving room 16 with the abutments 34 being resisted against the corresponding resistance faces 222. The socket 2 can move between the arms 15 in a lengthwise direction on the header 1. Furthermore, there is a space between the block 22 of the socket 2 and the arms 15 of the header 1, and “a” represents the width of the space, depicted in FIG. 6.

FIG. 6 illustrates a condition that the battery connector 100 engages with the complementary connector. Dashed line I illustrates the battery connector 100 is correctly inserted into the complementary connector, and dashed line II and III respectively show the battery connector 100 is inserted into the complementary connector with an upmost offset, wherein b represents the upmost offset. It should be noted that the width “a” is wider than the width of “b”. When the battery connector 100 is correctly inserted into the complementary connector, the bends 33 of the contacts 3 are deflected outwardly and allow the complementary connector favorably entering the battery connector 100. If the battery connector 100 is inserted into the complementary connector with no more than upmost offset, the socket 2 is driven to a preferable disposition in the lengthwise direction (represented by double arrows “c”) by an interference force produced between the battery connector 100 and the complementary connector, thereby further impelling the contacts 3 to the correct position. Due to the width “a” is wider than width “b”, the socket 2 obtains enough room to move in the lengthwise direction on the header 1, thereby avoiding the deformation or broken of terminals of the complementary connector.

It is to be understood, however, that even though numerous, characteristics and advantages of the present invention have been set fourth in the foregoing description, together with details of the structure and function of the invention, the disclosed is illustrative only, and changes may be made in detail, especially in matters of number, shape, size, and arrangement of parts within the principles of the invention to the full extent indicated by the broad general meaning of the terms in which the appended claims are expressed.

1. A battery connector adapted for mating with a complementary connector, comprising:
an insulative housing having a header, a socket movably mounted on the header to define a plurality of receiving rooms therebetween, the socket having a plurality of blocks and each defining a pair of chamfers for leading the complementary connector into the battery connector; and
a plurality of contacts retained in corresponding receiving rooms.

2. The battery connector according to claim 1, wherein each chamfer of the socket interiorly extends to form a resistance face.

3. The battery connector according to claim 2, wherein each contact defines a pair of cantilevered beams.

4. The battery connector according to claim 3, wherein each cantilevered beam comprises an abutment in a free end thereof for resisting the resistance face of the socket, and wherein the socket moves on the header and drives the contacts.

5. The battery connector according to claim 4, wherein the height of the resistance face is substantially equal to the abutment of the socket.

6. The battery connector according to claim 1, wherein the header defines a plurality of partitions and a plurality of receiving cavities.

7. The battery connector according to claim 6, wherein the socket defines a plurality of passageways, and wherein the passageways and the receiving cavities of the socket cooperatively form a plurality of receiving rooms retaining the contacts.

8. The battery connector according to claim 1, wherein the header defines a stepped portion and an end portion for resisting the socket in longitudinal direction.

9. The battery connector according to claim 8, wherein the end portion defines a longitudinal rib for further resisting the socket in a vertical direction.

10. A battery connector comprising:
an insulative housing including a header defining a lengthwise direction and a socket moveably relative to the header along said lengthwise direction; and
a plurality of contacts received in the housing and matable with a complementary connector along a front-to-back direction perpendicular to said lengthwise direction; wherein
said socket defines a plurality of blocks for not only guiding insertion of the complementary connector into the housing but also actuating the corresponding contacts to move in said lengthwise direction for compliantly coupling to the complementary connector.

11. The connector as claimed in claim 10, wherein said socket is assembled to the header in a vertical direction perpendicular to both said lengthwise direction and the front-to-back direction.

12. The connector as claimed in claim 10, wherein the blocks are equipped with chamfers for resulting in the movement of the socket in said lengthwise direction when the complementary connector is mated with the battery connector in an offset manner.

13. A method of mating a complementary connector to a battery connector, comprising steps of;
providing a battery connector with an insulative housing including a stationary header and a socket moveable relative to the header in a lengthwise direction;
providing said socket with a plurality of blocks thereof;
providing a plurality of contacts in the housing under a condition that a front ends of each of the contacts is actuated by the corresponding blocks;
inserting the complementary connector to the housing under a condition that the socket is moved in said lengthwise direction with the corresponding contacts being actuated to move together therewith for compliance with insertion of said complementary connector if said insertion is essentially of an offset manner.
